(19) United States
(12) Patent Application Publication
(10) Pub. No.: US 2012/0038968 A1
(43) Pub. Date: Feb. 16, 2012

(54) Strenthened electrochromic reflection structure

(76) Inventor: Fu-Hsin TSAI, Sioushuei Township (TW)

(21) Appl. No.: 12/856,631

(22) Filed: Aug. 14, 2010

(51) Int. Cl. G02F 1/153

(52) U.S. Cl. 359/273

(57) ABSTRACT

An strengthened electrochromic reflection structure comprises a substrate, an interfacial layer combined onto the substrate, a reflection layer combined onto the interfacial layer, a first conductive layer combined onto the reflection layer, an electrochromic layer combined onto the first conductive layer, a second conductive layer combined onto the electrochromic layer, and a panel combined onto the second conductive layer. By such arrangements, the reflectivity of the strengthened electrochromic reflection structure is increased when light is emitted onto the front surface of the strengthened electrochromic reflection structure, and the back light transmission is improved when light is emitted on the back surface of the strengthened electrochromic reflection structure.

### BACKGROUND OF THE INVENTION

1. Field of the Invention

The present invention relates to a reflection structure for controlling the intensity, the color, the phase, polarization or direction of the light from an independent light source; and more particularly to a strengthened electrochromic reflection structure.

2. Description of the Prior Art

Electrochromic material has the advantages of controllable penetration rate, fine memory effect, quick response, low driving voltage, long service life, and energy conservation.

FIG. 1 illustrates a conventional electrochromic structure for a rear-view mirror, as shown in FIG. 2, the conventional electrochromic structure 90 comprises a substrate 91, a first conductive layer 92, an electrochromic layer 93, a second conductive layer 94 and a panel 95 that are superposed one upon another. The above conventional electrochromic structure for a rear-view mirror can prevent glare by changing reflectivity and light transmission with voltage according to the light intensity.

The present invention has arisen to mitigate and/or obviate the afore-described disadvantages.

### SUMMARY OF THE INVENTION

The primary objective of the present invention is to provide a strengthened electrochromic reflection structure, the reflectivity of the strengthened electrochromic reflection structure is increased when light is emitted onto the front surface of the strengthened electrochromic reflection structure, and the back light transmission is improved when light is emitted on the back surface of the strengthened electrochromic reflection structure.

To achieve the above objective, a strengthened electrochromic reflection structure comprises a substrate, an interfacial layer, a reflection layer, a first conductive layer, an electrochromic layer, a second conductive layer and a panel.

The electrochromic layer, the second conductive layer and the panel together constitute an electrochromic structure. When being emitted onto the strengthened electrochromic reflection structure of the present invention, the light will be reflected out through the electrochromic structure by the reflection layer. The interfacial layer is made of the material selected from the group consisting of silicon dioxide, aluminum oxide, and magnesium fluoride. With the interfacial layer, the reflection layer and the substrate can be assuredly combined, and unwanted refraction or scattering can be reduced while the light passes through the interfacial layer, so that the information light emitted from the screen on the back surface of the strengthened electrochromic reflection structure can be effectively reflected by the strengthened electrochromic reflection structure and read by the user, improving the back light transmission.

Between the reflection layer and the first conductive layer is further provided a protecting layer, the protecting layer is made of the same material as the interfacial layer. The reflection layer and the reflection layer are made of materials having different densities to increase the reflectivity of the reflection layer effectively, consequently improving the reflectivity of the strengthened electrochromic reflection structure.

### BRIEF DESCRIPTION OF THE DRAWINGS

FIG. 1 is a cross-sectional view of a conventional electrochromic structure;

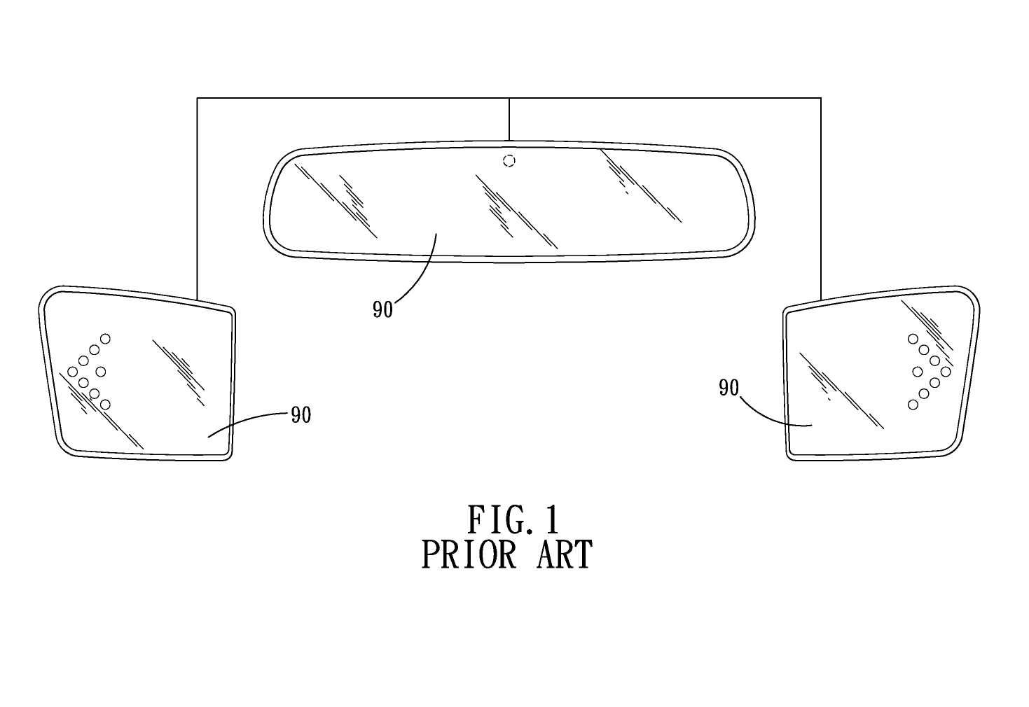

FIG. 2 is an operational view of the conventional electrochromic structure;

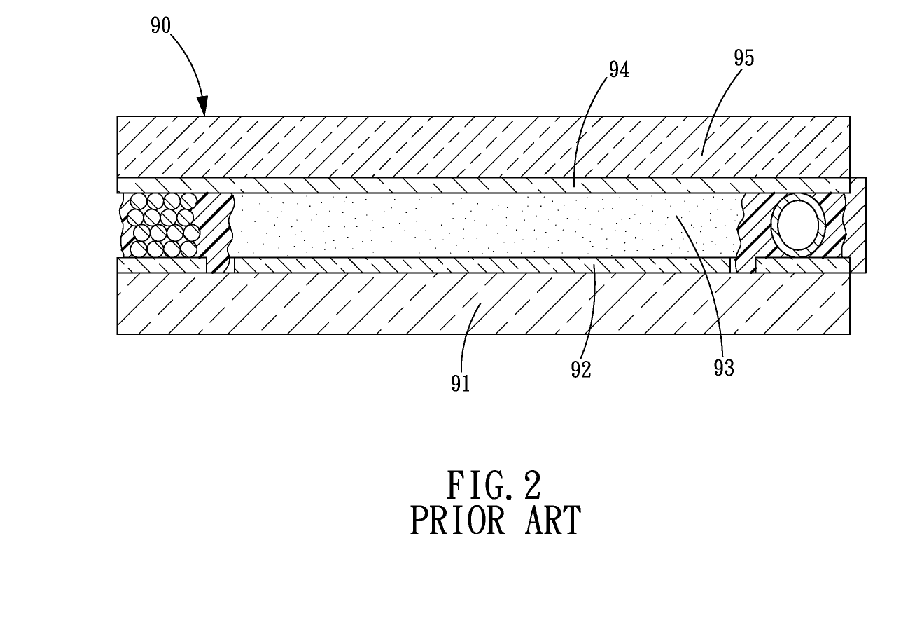

FIG. 3 is a cross-sectional view of a strengthened electrochromic reflection structure in accordance with the present invention; and

FIG. 4 is another cross-sectional view of the strengthened electrochromic reflection structure in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

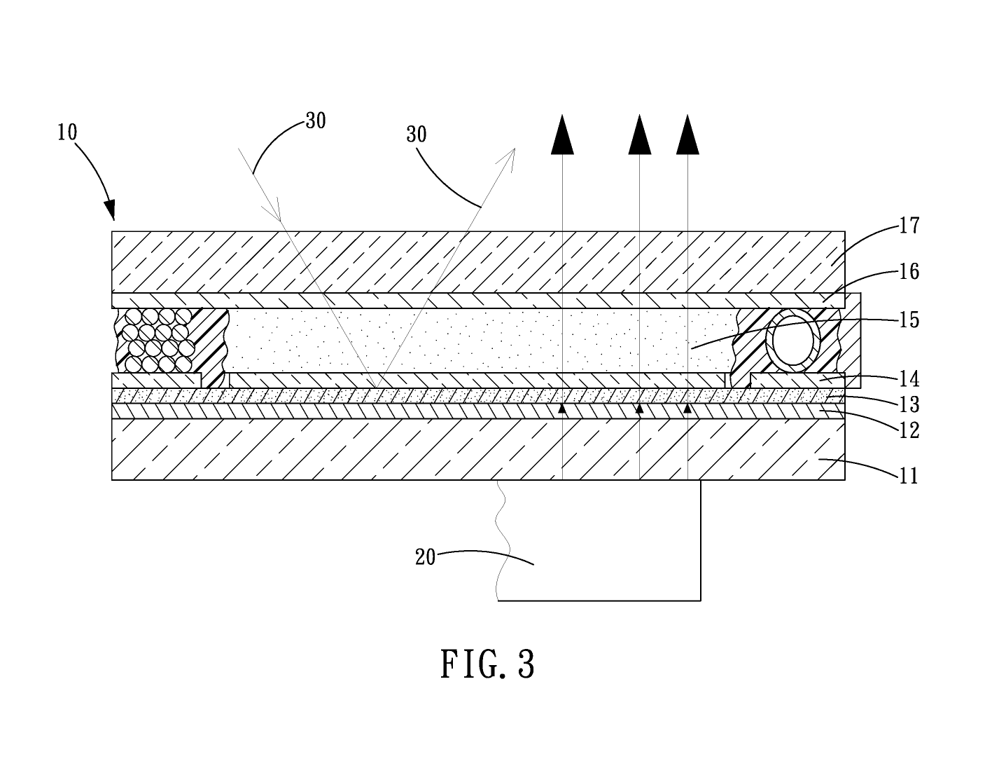

Referring to FIGS. 3-5, a strengthened electrochromic reflection structure 10 in accordance with a first embodiment of the present invention comprises a substrate 11, an interfacial layer 12, a reflection layer 13, a first conductive layer 14, an electrochromic layer 15, a second conductive layer 16 and a panel 17. The electrochromic layer 15, the second conductive layer 16 and the panel 17 together constitute an electrochromic structure.

The substrate 11 is made of a material selected from the group consisting of glass, polycarbonate and polymethylmethacrylate.

The interfacial layer 12 is made of aluminum oxide and has a thickness ranged from 200 Å to 1800 Å. The interfacial layer 12 is combined onto the substrate 11. The interfacial layer 12 can also be made of a material selected from the group consisting of silicon dioxide, indium tin oxide and magnesium fluoride.

The reflection later 13 is disposed on the interfacial layer 12 by metal coating and made of a material selected from the group consisting of silver having a purity higher than 4N, a silver-palladium alloy containing 3% palladium, a silver-palladium alloy containing 5% palladium, a silver-palladium-copper alloy containing 1% palladium and 2% copper, a silver-palladium-copper alloy containing 2% palladium and 1% copper, a silver-palladium-copper alloy containing 3% palladium or 5% palladium and 1% copper, a silver-copper alloy containing 3% copper, a platinum-silver alloy containing 2%, 4% or 7% platinum, a gold-silver alloy containing 2%, 4% or 7% gold. The reflection layer 13 has an electric resistance smaller than 5 Ω/cm² and a thickness ranged from 450 Å to 1000 Å. The reflection layer 13 is combined onto the interfacial layer 12.

The first conductive layer 14 is made of a material selected from the group consisting of titanium zinc, titanium and titanium alloys. The first conductive layer 14 has a thickness ranged from 50 Å to 200 Å. The first conductive layer 14 is combined onto the reflection layer 13. Alternatively, the first conductive layer 14 can also be made of a transparent conducting oxide selected from the group consisting of indium doped tin oxide, aluminum doped zinc oxide, gallium doped zinc oxide, fluorine-doped tin oxide, stannic oxide, and zinc oxide. The first conductive layer 14 is combined onto the reflection layer 13.

The electrochromic layer 15 is combined onto the first conductive layer 14, and the second conductive layer 16 is combined onto the electrochromic layer 15. The panel 17 is combined onto the second conductive layer 16. The above electrochromic layer 15, the second conductive layer 16 and the panel 17 are the conventional structures, so no further explanations are provided herein. The substrate 11 of the strengthened electrochromic reflection structure 10 of the present invention is further provided on a back surface thereof with a screen 20. The screen 20 emits information light onto the reflection structure 10, and the information light will be reflected by the strengthened electrochromic reflection structure 10 and read by the user from the panel 17. Since this is conventional art, no further discussion seems necessary.

With the arrangement of the substrate 11, the interfacial layer 12 and the reflection layer 13, the reflectivity and the back light transmission of the strengthened electrochromic reflection structure 10 in accordance with the present invention can be improved.

Alternatively, the interfacial layer 12 can also be a coating made of chromium or nickel chromium alloy and has a thickness ranged from 200 Å to 400 Å. The interfacial layer 12 is provided to form an interface strengthening the adhesive force between the substrate 11 and the reflection layer 13. Due to its non-metallic structure having the metallic features, the interfacial layer 12 can assuredly combine the non-metallic substrate 11 and the metallic reflection layer 13 integrally, improving the product stability.

A light path of the strengthened electrochromic reflection structure 10 in accordance with the first embodiment of the present invention is described as follows: When light 30 pass through the electrochromic layer 15 from the panel 17 to the reflection layer 13, a large proportion of the light 30 will be reflected out of the strengthened electrochromic reflection structure 10 by the reflection layer 13. Since the interfacial layer 12 is made of a material having a density smaller than that of the reflection layer 13, when the screen 20 on the back surface of the substrate 11 emits the information light, the information light will enter the interfacial layer 12 directly from the substrate 11 and then reach the reflection layer 13, after that, the information light will pass through the reflection layer 13 in an accelerated manner and finally transmit out of the strengthened electrochromic reflection structure 10 of the present invention through the first conductive layer 14, the electrochromic layer 15 and the second conductive layer 16, thus providing a higher back light transmission while greatly reducing the light refraction and light scattering.

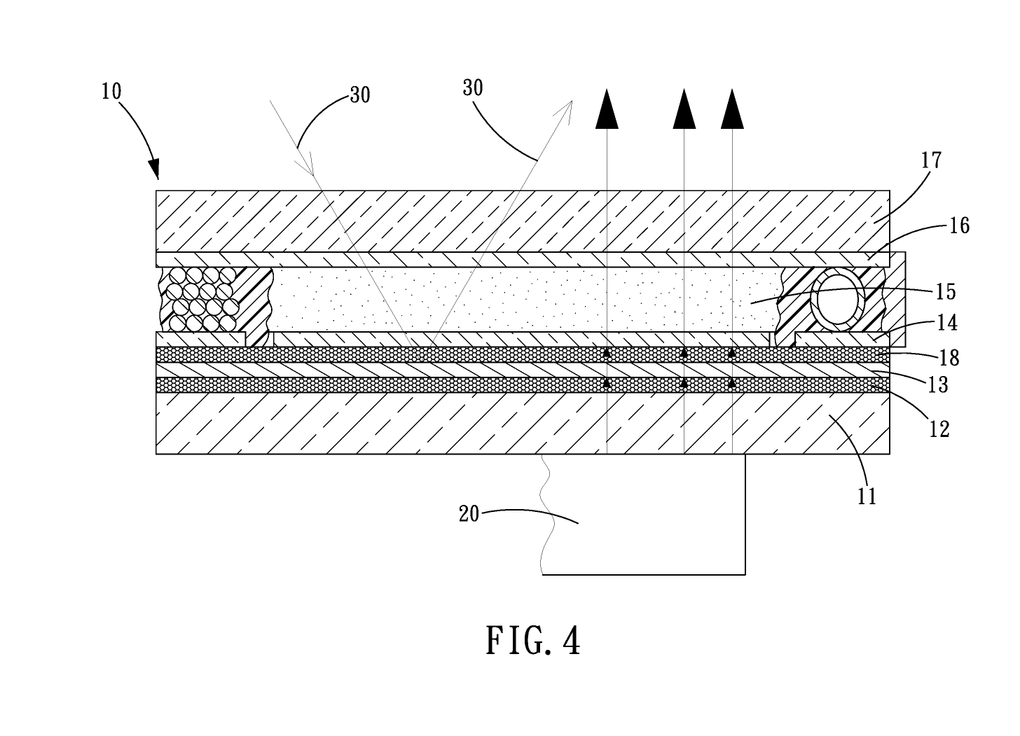

Referring to FIG. 4, a strengthened electrochromic reflection structure 10 in accordance with a second embodiment of the present invention comprises a substrate 11, an interfacial layer 12, a reflection layer 13, a protecting layer 18, a first conductive layer 14, an electrochromic layer 15, a second conductive layer 16 and a panel 17. The substrate 11, the interfacial layer 12, the reflection layer 13, the first conductive layer 14, the electrochromic layer 15, the second conductive layer 16, and the panel 17 are the same as the corresponding elements of the previous embodiment in structure, but the interfacial layer 12 is made of pure aluminum having a purity higher than 4N. Between the reflection layer 13 and the first conductive layer 14 is disposed the protecting layer 18 which is made of the same material as the interfacial layer 12 in the previous embodiment, and the remaining layers of the second embodiment are made of the same materials as the previous embodiment.

A light path of the strengthened electrochromic reflection structure 10 in accordance with the second embodiment of the present invention is described as follows: When the light 30 are projected onto the protecting layer 18 and the reflection layer 13 from the panel 17 through the electrochromic layer 15, although a large proportion of the light 30 are reflected out by the protecting layer 18, since the density of the protecting layer 18 is smaller than that of the reflection layer 13, the light 30 which enter the protecting layer 18 will be projected onto the reflection layer 13 in an accelerated manner and then reflected by the reflection layer 13, avoiding the scattering loss before the reflection of the reflection layer 13 while effectively reflecting the light out. After being emitted from the screen 20, the information light will pass through the substrate 11, the interfacial layer 12, the reflection layer 13, the protecting layer 18, the first conductive layer 14, the electrochromic layer 15, the second conductive layer 16 and the panel 17, respectively, and will finally be read by the user. By such arrangements, it can be found that the reflectivity of the present invention can be improved if light is projected onto a front surface of the strengthened electrochromic reflection structure, while the light transmission can be improved if light is emitted from a back surface of the strengthened electrochromic reflection structure.

Our tests show that the reflectivity of the present invention can be improved due to the arrangement of the reflection layer 13 and the protecting layer 18. For example, when the reflection layer 13 is made by aluminum plating, the reflectivity can be improved from 85% to 92%. Furthermore, the strengthened electrochromic reflection structure 10 in accordance with the present invention still has the electricity conductive function.

While we have shown and described various embodiments in accordance with the present invention, it is clear to those skilled in the art that further embodiments may be made without departing from the scope of the present invention.

What is claimed is:

1. A strengthened electrochromic reflection structure being disposed on an electrochromic structure, comprising:
a substrate;
an interfacial layer combined onto the substrate;
a reflection layer combined onto the interfacial layer;
a first conductive layer combined onto the reflection layer;
the first conductive layer combined to a electrochromic structure;
wherein the reflection layer is disposed on the electrochromic structure by metal coating, the interfacial layer is made of a material having a density smaller than a density of a material making the reflection layer, a thickness of the interfacial layer is ranged from 200 Å to 1800 Å.

2. The strengthened electrochromic reflection structure as claimed in claim 1, wherein the substrate is made of a material selected from the group consisting of glass, polycarbonate and polymethylmethacrylate.

3. The strengthened electrochromic reflection structure as claimed in claim 1, wherein the interfacial layer is made of made of aluminum oxide.

4. The strengthened electrochromic reflection structure as claimed in claim 1, wherein the interfacial layer is made of chromium or nickel chromium alloy and has a thickness ranged from 200 Å to 400 Å.

5. The strengthened electrochromic reflection structure as claimed in claim 1, wherein the interfacial layer is made of silicon dioxide.

6. The strengthened electrochromic reflection structure as claimed in claim 1, wherein the interfacial layer is made of magnesium fluoride.

7. The strengthened electrochromic reflection structure as claimed in claim 1, wherein the reflection layer is disposed on the interfacial layer by metal coating and made of a material selected from the group consisting of silver having a purity higher than 4N, a silver-palladium alloy containing 3% palladium, a silver-palladium alloy containing 5% palladium, a silver-palladium-copper alloy containing 1% palladium and 2% copper, a silver-palladium-copper alloy containing 2% palladium and 1% copper or containing 3% palladium or 5% palladium and 1% copper, a silver-copper alloy containing 3% copper, a platinum-silver alloy containing 2% platinum, a gold-silver alloy containing 2%, 4% or 7% gold, the reflection layer 13 has a resistance smaller than 5Ω/□ and a thickness ranged from 450 Å to 1000 Å.

8. The strengthened electrochromic reflection structure as claimed in claim 1, wherein the first conductive layer is made of a material selected from the group consisting of titanium zinc, titanium and titanium alloys.

9. The strengthened electrochromic reflection structure as claimed in claim 1, wherein the first conductive layer is made of a transparent conducting oxide selected from the group consisting of indium doped tin oxide, aluminum doped zinc oxide, gallium doped zinc oxide, fluorine-doped tin oxide, stannic oxide and zinc oxide, and the first conductive layer has a thickness ranged from 50 Å to 200 Å.

10. The strengthened electrochromic reflection structure as claimed in claim 9, wherein a protecting layer is disposed between the reflection layer and the first conductive layer, the reflection layer is made by aluminum plating, the protecting layer is made of the same material as the interfacial layer, including silicon dioxide and magnesium fluoride.

11. An strengthened electrochromic reflection structure comprising:
a substrate;
an interfacial layer combined onto the substrate;
a reflection layer combined onto the reflection layer;
a first conductive layer combined onto the reflection layer;
an electrochromic layer combined onto the first conductive layer;
a second conductive layer combined onto the electrochromic layer; and
a panel combined onto the second conductive layer;
wherein the reflection layer is disposed on the interfacial layer by metal coating, the interfacial layer is made of a material having a density smaller than a density of a material making the reflection layer, a thickness of the interfacial layer is ranged from 200 Å to 1800 Å.
